(19) United States
(12) Patent Application Publication
(10) Pub. No.: US 2021/0366467 A1
(43) Pub. Date: Nov. 25, 2021

(54) SLANG IDENTIFICATION AND EXPLANATION

(71) Applicant: International Business Machines Corporation, Armonk, NY (US)

(72) Inventors: June-Ray Lin, Songshan District (TW); Jin Zhang, Beijing (CN); Ju Ling Liu, Beijing (CN); Li Bo Zhang, Beijing (CN); Nan Chen, Beijing (CN)

(21) Appl. No.: 16/879,237

(22) Filed: May 20, 2020

(51) Int. Cl. G10L 15/18; G10L 15/06; G10L 15/02; G10L 25/63; G06K 9/62

(52) U.S. Cl. CPC G10L 15/1815; G10L 15/063; G06K 9/6218; G10L 25/63; G10L 15/02

(57) ABSTRACT

A plurality of slang sentences and respective explanations for the plurality of slang sentences are extracted from audio or video data. A set of training samples are generated by clustering the plurality of slang sentences and the explanations. Each of the training samples comprises at least one slang sentence and at least one explanation corresponding to same slang. A model is trained based on the set of training samples, such that the trained model identifies slang from an input sentence and provides at least one explanation for the identified slang. In other embodiments, another method, systems and computer program products are disclosed.

### BACKGROUND

The present disclosure relates to natural language processing, and more specifically, to methods, systems, and computer program products for slang identification and explanation.

Usually, there may be slang in live audio or video. Slang is difficult to understand especially for a non-native speaker or someone who has no background knowledge about the topic. Therefore, how to automatically identify and explain slang from live audio or video would be a challenging task.

### SUMMARY

According to some embodiments of the present disclosure, there is provided a computer-implemented method. The method comprises extracting a plurality of slang sentences and respective explanations for the plurality of slang sentences from audio or video data. The method further comprises generating a set of training samples by clustering the plurality of slang sentences and the explanations. Each of the training samples comprises at least one slang sentence and at least one explanation corresponding to same slang. The method further comprises training a model based on the set of training samples, such that the model identifies slang from an input sentences and provides at least one explanation for the identified slang.

According to some embodiments of the present disclosure, there is provided a computer-implemented method. The method comprises receiving an input sentence from a user. The method further comprises identifying slang from the input sentence. The method further comprises in response to the slang being identified, providing at least one explanation for the slang to the user.

According to some embodiments of the present disclosure, there is provided a system. The system comprises a processing unit and a memory coupled to the processing unit. The memory stores instructions that, when executed by the processing unit, perform actions comprising: extracting a plurality of slang sentences and respective explanations for the plurality of slang sentences from audio or video data; generating a set of training samples by clustering the plurality of slang sentences and the explanations, each of the training samples comprising at least one slang sentence and at least one explanation corresponding to same slang; and training a model based on the set of training samples, such that the model identifies slang from an input sentence and provides at least one explanation for the identified slang.

According to some embodiments of the present disclosure, there is provided a system. The system comprises a processing unit and a memory coupled to the processing unit. The memory stores instructions that, when executed by the processing unit, perform actions comprising: receiving an input sentence from a user; identifying slang from the input sentence; and in response to the slang being identified, providing at least one explanation for the slang to the user.

According to some embodiments of the present disclosure, there is provided a computer program product. The computer program product is tangibly stored on non-transient machine-readable medium and comprises machine-executable instructions. The machine-executable instructions, when executed on a device, cause the device to perform acts comprising: extracting a plurality of slang sentences and respective explanations for the plurality of slang sentences from audio or video data; generating a set of training samples by clustering the plurality of slang sentences and the explanations, each of the training samples comprising at least one slang sentence and at least one explanation corresponding to same slang; and training a model based on the set of training samples, such that the model identifies slang from an input sentence and provides at least one explanation for the identified slang.

According to some embodiments of the present disclosure, there is provided a computer program product. The computer program product is tangibly stored on non-transient machine-readable medium and comprises machine-executable instructions. The machine-executable instructions, when executed on a device, cause the device to perform acts comprising: receiving an input sentence from a user; identifying slang from the input sentence; and in response to the slang being identified, providing at least one explanation for the slang to the user.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts a system according to embodiments of the present disclosure.

FIG. 5 depicts a schematic diagram for extracting slang sentences and explanations from training data according to embodiments of the present disclosure.

FIG. 6 depicts a schematic diagram for generating training samples by clustering the identified slang sentences and explanations according to embodiments of the present disclosure.

FIG. 7 depicts a flowchart of an example method for training a slang identification and explanation model according to embodiments of the present disclosure.

FIG. 8 depicts a flowchart of an example method for slang identification and explanation according to embodiments of the present disclosure.

Throughout the drawings, same or similar reference numerals represent the same or similar elements.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

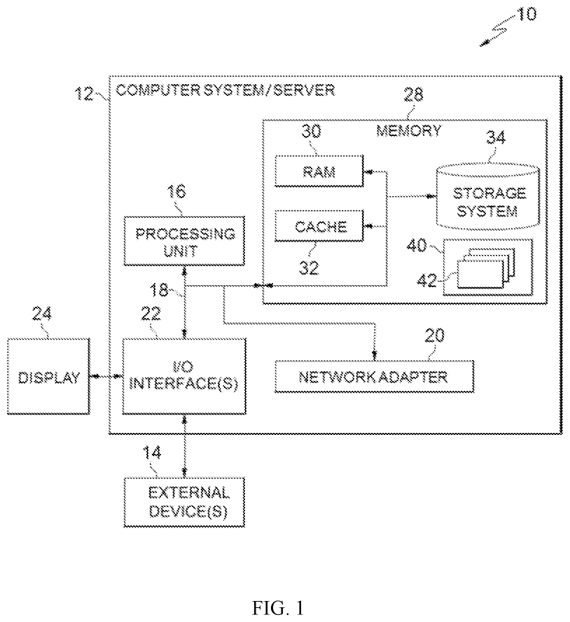

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

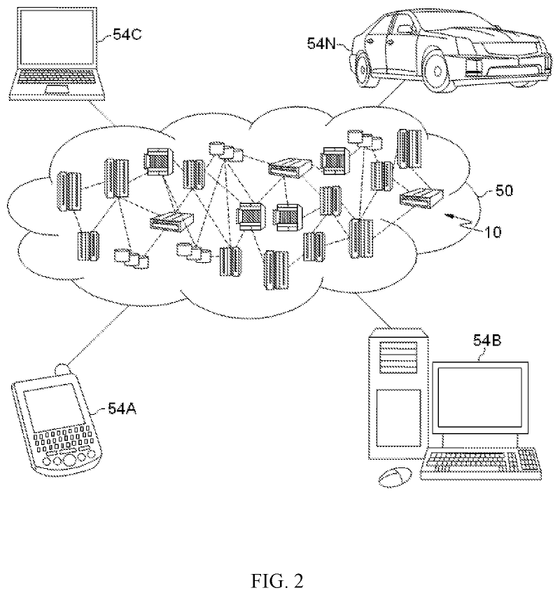

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer MB, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

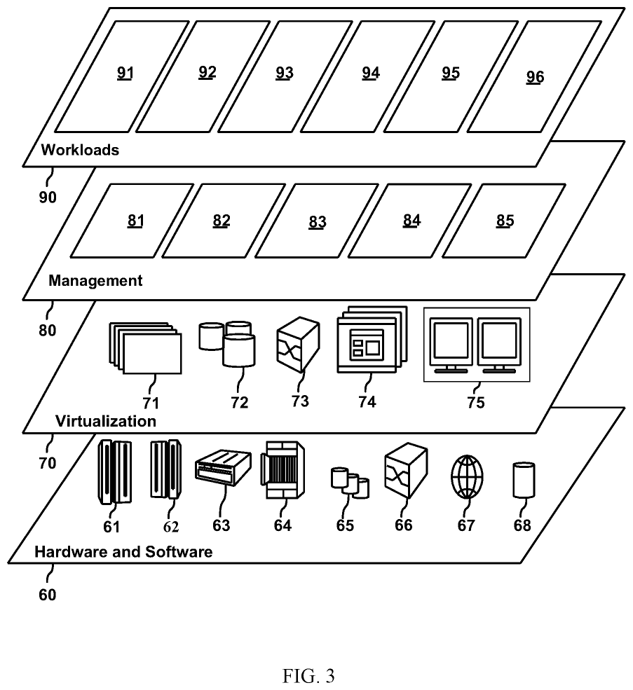

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

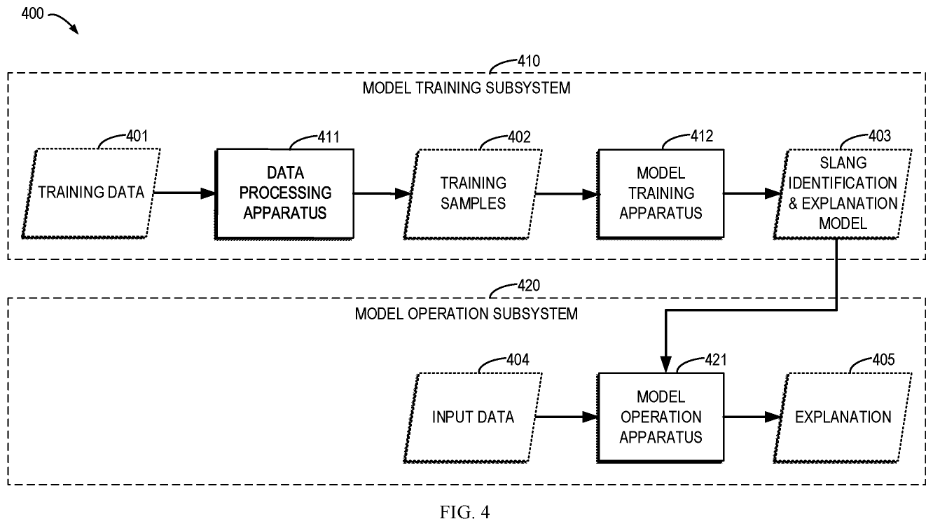

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and slang identification 96. Hereinafter, reference will be made to FIG. 4 to FIG. 7 to describe details of the slang identification 96.

As described above, there may be slang in live audio or video. Slang is difficult to understand especially for a non-native speaker or someone who has no background knowledge about the topic. Therefore, how to automatically identify and understand slang from live audio or video would be a challenging task.

In order to at least partially solve the above and other potential problems, embodiments of the present disclosure provide a solution for slang identification and explanation. According to embodiments of the present disclosure, a plurality of slang sentences and respective explanations for the plurality of slang sentences are extracted from audio or video data by capturing emotional reactions to slang. A set of training samples are generated by clustering the plurality of slang sentences and the explanations. Each of the training samples comprises at least one slang sentence and at least one explanation corresponding to same slang. A model is trained based on the set of training samples, such that the model can identify slang from a sentence input by a user and provide at least one explanation for the identified slang to the user.

With reference now to FIG. 4, a system 400 in which embodiments of the present disclosure can be implemented is shown. It is to be understood that the structure and functionality of the system 400 are described only for the purpose of illustration without suggesting any limitations as to the scope of the present disclosure. The embodiments of the present disclosure can be embodied with a different structure and/or functionality.

As shown in FIG. 4, the system 400 may generally comprise a model training subsystem 410 and a model operation subsystem 420. The model training subsystem 410 may comprise a data processing apparatus 411 and a model training apparatus 412. The model operation subsystem 420 may comprise a model operation apparatus 421. In some embodiments, the data processing apparatus 411, the model training apparatus 412 and the model operation apparatus 421 can be implemented in different physical devices, respectively. Alternatively, in some embodiments, some of the data processing apparatus 411, the model training apparatus 412 and the model operation apparatus 421 can be implemented in a same physical device. For example, at least part or all of the data processing apparatus 411, the model training apparatus 412 and the model operation apparatus 421 may be implemented by computer system/server 12 of FIG. 1

According to embodiments of the present disclosure, the solution for slang identification and explanation may comprise two phases: a model training phase and a model operation phase.

During the model training phase, the data processing apparatus 411 may receive training data 401 including slang. The training data 401 may include audio or video data related to a live speech, in which one or more audiences are listening to a speaker. For example, emotional reactions of the audiences to slang can be captured from the audio or video data. The training data 401 may also include text data converted from a live speech, in which one or more audiences are listening to a speaker. For example, the text data may include indications of emotional reactions of the audiences to slang. Only for the purpose of illustration, in the following, audio or video data will be taken as an example of the training data 401.

The data processing apparatus 411 may extract a plurality of slang sentences and their respective explanations from the training data 401. As used herein, a “slang sentence” refers to a sentence which may include slang. The data processing apparatus 411 may generate a set of training samples 402 by clustering the plurality of slang sentences and their respective explanations. Each of the training samples 402 may include at least one slang sentence and at least one explanation corresponding to same slang. The model training apparatus 412 may train a slang identification and explanation model 403 based on the set of training samples 402. The slang identification and explanation model 403 may be trained based on a machine learning algorithm. The trained slang identification and explanation model 403 can identify slang from a sentence input by a user and provide, to the user, at least one explanation for the slang if it is identified.

In some embodiments, in order to extract the plurality of slang sentences and their respective explanations from the training data 401, the data processing apparatus 411 may capture an emotional reaction of the audiences to slang from the training data 401 and determine a time slot when slang appears in the training data 401 based on the captured emotional reaction. In some embodiments, the emotional reaction may include at least one of the following: laughter, applause, silence and the like. In response to determining the time slot of the emotional reaction, the data processing apparatus 411 may extract, from the training data 401, a first segment before the time slot and a second segment after the time slot. The first segment may be of a first predetermined time duration, for example, X minutes (where X>0). The second segment may be of a second predetermined time duration, for example, Y minutes (where Y>0). Then, the data processing apparatus 411 may extract a slang sentence triggering the emotional reaction from the first segment and extract an explanation for the slang sentence from the second segment.

In some embodiments, if the training data 401 is audio or video data, in order to extract a slang sentence from the first segment, the data processing apparatus 411 may convert the first segment into a first text. Alternatively, if the training data 401 is text data, the first segment can act as the first text directly. The data processing apparatus 411 may use a slang sentence identification model to identify a slang sentence triggering the emotional reaction from the first text. In some cases, the slang sentence can be identified from the first text. In response to the slang sentence being identified, the data processing apparatus 411 may extract the slang sentence from the first text. In other cases, the first text may not include a slang sentence. For example, no slang sentence can be identified from the first text by the slang sentence identification model. In this event, the data processing apparatus 411 may not need to extract an explanation from the second segment. It is to be understood that the slang sentence identification model can be trained based on any algorithm currently known or to be developed in the future. The scope of the present disclosure will not be limited in this aspect.

In some embodiments, if the training data 401 is audio or video data, in order to extract the explanation for the slang sentence from the second segment, the data processing apparatus 411 may convert the second segment into a second text. Alternatively, if the training data 401 is text data, the second segment can act as the second text directly. The data processing apparatus 411 may use an explanation identification model to identify at least one sentence for explaining the slang sentence from the second text. In some cases, the at least one sentence for explaining the slang sentence can be identified from the second text. In response to the at least one sentence being identified, the data processing apparatus 411 may extract the at least one sentence from the second text as the explanation for the slang sentence. In other cases, the second text may not include an explanation for the slang sentence. For example, no explanation can be identified from the second text by the explanation identification model. In this event, the data processing apparatus 411 may discard the slang sentence extracted from the first text, since no explanation is available for the slang sentence. It is to be understood that the explanation identification model can be trained based on any algorithm currently known or to be developed in the future. The scope of the present disclosure will not be limited in this aspect.

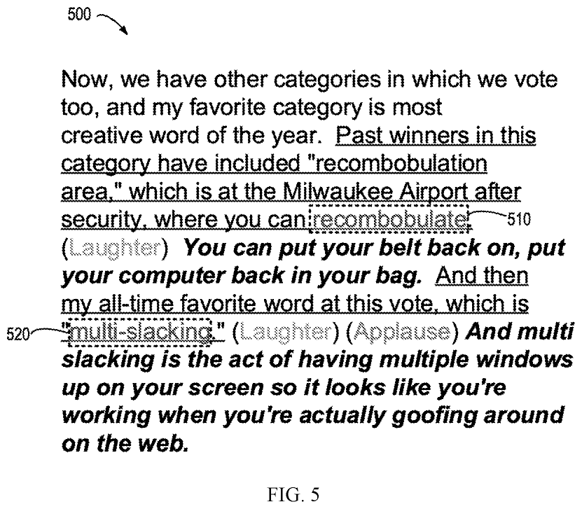

FIG. 5 depicts a schematic diagram for extracting slang sentences and explanations from training data according to embodiments of the present disclosure. For example, FIG. 5 shows a text 500 which is converted from a live speech. As shown in FIG. 5, for example, laughter is captured after a word “recombobulate” (denoted by 510), which may be potential slang. Moreover, laughter and applause are captured after a word “multi-slacking” (denoted by 520), which may also be potential slang. The data processing apparatus 411 may extract a slang sentence “Past winners in this category have included ‘recombobulation area’, which is at the Milwaukee Airport after security, where you can recombobulate” and a corresponding explanation “You can put your belt back on, put your computer back in your bag” based on the captured first laughter after the word 510. The data processing apparatus 411 may also extract a slang sentence “And then my all-time favorite word at this vote, which is ‘multi-slacking’” and a corresponding explanation “And multi slacking is the act of having multiple windows up on your screen so it looks like you're working when you're actually goofing around on the web” based on the captured laughter and applause after the word 520.

In some embodiments, in response to extracting the plurality of slang sentences and their respective explanations from the training data 401, the data processing apparatus 411 may cluster the plurality of slang sentences into slang categories based on their semantic similarities. Each of the slang categories may include one or more slang sentences whose semantic similarity exceeds a threshold, which means that the one or more slang sentences may contain same slang. For example, slang sentences “you look like a million dollars” and “you look like a million bucks” can be clustered into a same slang category, since both of them means that you look really beautiful. For example, slang sentences “I feel under the weather today” and “I feel not myself today” can be clustered into a same slang category, since both of them means that I feel sick. It is to be understood that, any clustering algorithm currently known or to be developed in the future can be used for clustering the plurality of slang sentences. The scope of the present disclosure will not be limited in this aspect. The data processing apparatus 411 may then map the explanations of the plurality of slang sentences into the slang categories. That is, each of the slang categories may include one or more slang sentences and a set of explanations corresponding to the one or more slang sentences. In some embodiment, the data processing apparatus 411 may generate one of the training samples 402 for each of the slang categories. For example, one of the training samples 402 may include one or more slang sentences and a set of explanations that belong to a corresponding slang category.

Alternatively, or in addition, in some embodiments, in order to improve the training efficiency of the slang identification and explanation model 403, the data processing apparatus 411 may further cluster explanations mapped to a same slang category into explanation categories based on similarities of these explanations. It is to be understood that, any clustering algorithm currently known or to be developed in the future can be used for clustering explanations mapped to a same slang category. The scope of the present disclosure will not be limited in this aspect. In some embodiments, for each of the explanation categories, the data processing apparatus 411 may select an optimal explanation as a baseline explanation. For example, the longest explanation in each of the explanation categories can be selected as the baseline explanation. Alternatively, semantic integrity analysis may be performed on explanations in each of the explanation categories. An explanation with the highest semantic integrity in each of the explanation categories can be selected as the baseline explanation. Alternatively, in some embodiments, the data processing apparatus 411 may select any of explanations in each of the explanation categories as the baseline explanation. Then, the data processing apparatus 411 may generate one of the training samples 402 for each of the slang categories. For example, one of the training samples 402 may include one or more slang sentences belonging to a corresponding slang category and baseline explanations mapped to the corresponding slang category.

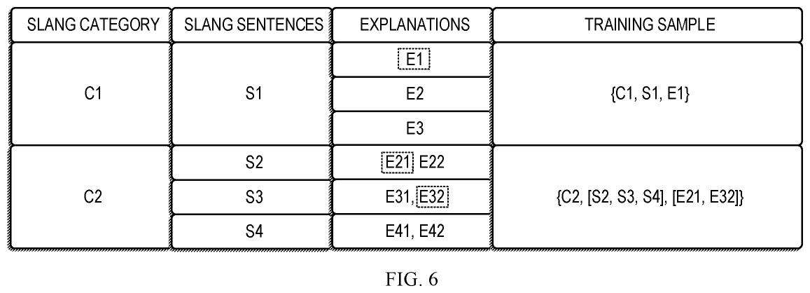

FIG. 6 depicts a schematic diagram for generating training samples by clustering the identified slang sentences and explanations according to embodiments of the present disclosure. As shown in FIG. 6, slang sentences S1, S2, S3 and S4 are clustered into two slang categories C1 and C2, in which the slang category C1 includes the slang sentence S1 and the slang category C2 includes the slang sentences S2, S3 and S4. Explanations E1, E2 and E3 for the slang sentence S1 are mapped to the slang category C1. For example, the explanations E1, E2 and E3 may clustered into a same explanation category, for which the explanation E1 is selected as the baseline explanation. Therefore, as shown in FIG. 6, one training sample may be generated for the slang category C1, which is represented as {C1, S1, E1}. Explanations E21 and E22 for the slang sentence S2, explanations E31 and E32 for the slang sentence S3, and explanations E41 and E42 for the slang sentence S4 are mapped to the other slang category C2. For example, the explanations E21, E22, E31, E32, E41 and E42 may clustered into two explanation categories, in which the explanations E21, E31, E41 and E42 belong to one explanation category and the explanations E22 and E32 belong to the other explanation category. For example, as shown in FIG. 6, the explanations E21 and E32 are selected as baseline explanations for the two explanation categories, respectively. Therefore, one training sample may be generated for the slang category C2, which is represented as {C2, [S2, S3, S4], [E21, E32]}.

In some embodiments, as described above, the model training apparatus 412 may train the slang identification and explanation model 403 based on the set of training samples 402. The slang identification and explanation model 403 may be trained based on a machine learning algorithm, such as, any suitable deep learning algorithm currently known or to be developed in the future. In some embodiments, the model training apparatus 412 may train the slang identification and explanation model 403, such that the slang identification and explanation model 403 can determine, from a sentence input by a user, a slang category associated with the sentence and provide at least one explanation mapped to the determined slang category to the user. For example, when the slang identification and explanation model 403 receives an input sentence and determine that the input sentence is associated with the slang category C2 as shown in FIG. 6, the slang identification and explanation model 403 may output at least one of the explanations E21 and E32. In some embodiments, the slang identification and explanation model 403 may be continuously trained by the model training apparatus 412 to learn more slang from further audios or videos. It is to be understood that, the slang identification and explanation model 403 can be adapted to different natural languages, including but not limited to English, Chinese, French and so on. The scope of the present disclosure will not be limited in this aspect.

With reference back to FIG. 4, the slang identification and explanation model 403 may be provided to the model operation apparatus 421. During the model operation phase, the model operation apparatus 421 may receive input data 404 from a user. The input data 404 may be a text (such as, a sentence), audio data or video data. If the input data 404 is audio or video data, it can be converted into text, such as one or more sentences. The model operation apparatus 421 may use the slang identification and explanation model 403 to identify slang from an input sentence and in response to the slang being identified from the input sentence, provide at least one explanation 405 for the identified slang to the user. In some embodiments, the slang identification and explanation model 403 may determine, from the input sentence, a slang category associated with the input sentence and provide the at least one explanation 405 mapped to the determined slang category to the user. For example, when the slang identification and explanation model 403 receives an input sentence and determine that the input sentence is associated with the slang category C2 as shown in FIG. 6, the slang identification and explanation model 403 may output at least one of the explanations E21 and E32. It is to be understood that the slang identification and explanation model 403 can identify slang included in the training samples 402 and can provide at least one explanation for the identified slang included in the training samples 402. If the input sentence contains new slang that is absent in the training samples 402, the slang identification and explanation model 403 may be unable to identify the new slang or provide an explanation for the new slang.

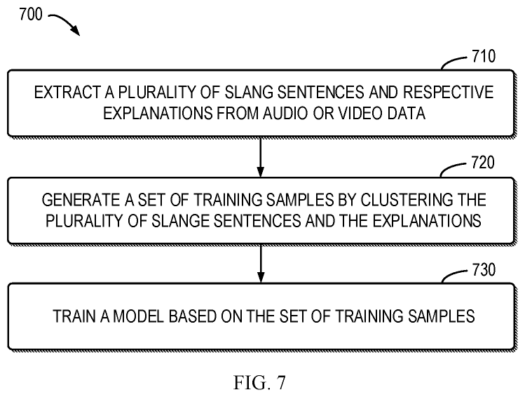

FIG. 7 depicts a flowchart of an example method 700 for training a slang identification and explanation model according to embodiments of the present disclosure. For example, the method 700 may be implemented by the model training subsystem 410 as shown in FIG. 4. It is to be understood that the method 700 may also comprise additional blocks (not shown) and/or may omit the illustrated blocks. The scope of the present disclosure described herein is not limited in this aspect.

At block 710, the model training subsystem 410 extracts a plurality of slang sentences and respective explanations for the plurality of slang sentences from audio or video data.

In some embodiments, the model training subsystem 410 may extract the plurality of slang sentences and the explanations by determining a time slot when slang appears in the audio or video data by capturing an emotional reaction to the slang from the audio or video data; extracting a first segment before the time slot and a second segment after the time slot from the audio or video data; extracting a slang sentence triggering the emotional reaction from the first segment; and extracting an explanation for the slang sentence from the second segment.

In some embodiments, the emotional reaction may comprise at least one of the following: laughter, applause, and silence.

In some embodiments, the model training subsystem 410 may extract the slang sentence from the first segment by converting the first segment into a first text; identifying a slang sentence triggering the emotional reaction from the first text by using a slang sentence identification model; and in response to the slang sentence being identified, extracting the slang sentence from the first text.

In some embodiments, the model training subsystem 410 may extract the explanation for the slang sentence from the second segment by converting the second segment into a second text; identifying at least one sentence for explaining the slang sentence from the second text by using an explanation identification model; and in response to the at least one sentence being identified, extracting the at least one sentence from the second text as the explanation for the slang sentence.

At block 720, the model training subsystem 410 generates a set of training samples by clustering the plurality of slang sentences and the explanations. Each of the training samples comprises at least one slang sentence and at least one explanation corresponding to same slang.

In some embodiments, the model training subsystem 410 may cluster the plurality of slang sentences and the explanations by clustering the plurality of slang sentences into slang categories, one of the slang categories comprising one or more slang sentences corresponding to same slang; and mapping the explanations into the slang categories.

In some embodiments, the model training subsystem 410 may generate the set of training samples by generating one of the training samples based on the one or more slang sentences and a set of explanations mapped to the one of the slang categories.

In some embodiments, the model training subsystem 410 may generate the one of the training samples by clustering the set of explanations into explanation categories; determining respective baseline explanations for the explanation categories; and generating the one of the training samples based on the one or more slang sentences and the baseline explanations.

At block 730, the model training subsystem 410 trains a model based on the set of training samples, such that the model identifies slang from an input sentence and provides at least one explanation for the identified slang.

In some embodiments, the model training subsystem 410 may train the model based on the set of training samples, such that the model determines a slang category associated with the input sentence and provides the at least one explanation mapped to the determined slang category.

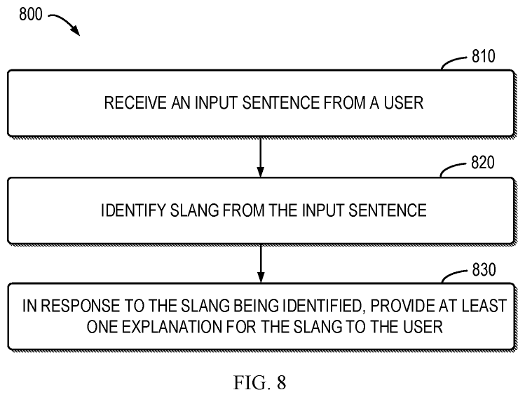

FIG. 8 depicts a flowchart of an example method 800 for slang identification and explanation according to embodiments of the present disclosure. For example, the method 800 may be implemented by the model operation subsystem 420 as shown in FIG. 4. It is to be understood that the method 800 may also comprise additional blocks (not shown) and/or may omit the illustrated blocks. The scope of the present disclosure described herein is not limited in this aspect.

At block 810, the model operation subsystem 420 receives an input sentence from a user.

At block 820, the model operation subsystem 420 identifies slang from the input sentence.

At block 830, in response to the slang being identified, the model operation subsystem 420 provides at least one explanation for the slang to the user.

In some embodiments, the model operation subsystem 420 may use a slang identification and explanation model to identify slang from the input sentence and provide at least one explanation for the identified slang if it is identified. In some embodiments, the slang identification and explanation model can be trained according to the method 700 as described above with reference to FIG. 7.

It should be noted that the slang identification and explanation according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
extracting, by one or more processors, a plurality of slang sentences and respective explanations for the plurality of slang sentences from audio or video data;
generating, by one or more processors, a set of training samples by clustering the plurality of slang sentences and the explanations, each of the training samples comprising at least one slang sentence and at least one explanation corresponding to same slang; and
training, by one or more processors, a model based on the set of training samples, such that the model identifies slang from an input sentence and provides at least one explanation for the identified slang.

2. The method of claim 1, wherein extracting the plurality of slang sentences and the explanations comprises:
determining, by one or more processors, a time slot when slang appears in the audio or video data by capturing an emotional reaction to the slang from the audio or video data;
extracting, by one or more processors, a first segment before the time slot and a second segment after the time slot from the audio or video data;
extracting, by one or more processors, a slang sentence triggering the emotional reaction from the first segment; and
extracting, by one or more processors, an explanation for the slang sentence from the second segment.

3. The method of claim 2, wherein the emotional reaction is selected from the group consisting of laughter, applause, and silence.

4. The method of claim 2, wherein extracting the slang sentence from the first segment comprises:
converting, by one or more processors, the first segment into a first text;
identifying, by one or more processors, a slang sentence triggering the emotional reaction from the first text by using a slang sentence identification model; and
in response to the slang sentence being identified, extracting, by one or more processors, the slang sentence from the first text.

5. The method of claim 2, wherein extracting the explanation for the slang sentence from the second segment comprises:
converting, by one or more processors, the second segment into a second text;
identifying, by one or more processors, at least one sentence for explaining the slang sentence from the second text by using an explanation identification model; and
in response to the at least one sentence being identified, extracting, by one or more processors, the at least one sentence from the second text as the explanation for the slang sentence.

6. The method of claim 1, wherein clustering the plurality of slang sentences and the explanations comprises:
clustering, by one or more processors, the plurality of slang sentences into slang categories, one of the slang categories comprising one or more slang sentences corresponding to same slang; and
mapping, by one or more processors, the explanations into the slang categories.

7. The method of claim 6, wherein generating the set of training samples comprises:
generating, by one or more processors, one of the training samples based on the one or more slang sentences and a set of explanations mapped to the one of the slang categories.

8. The method of claim 7, wherein generating the one of the training samples comprises:
clustering, by one or more processors, the set of explanations into explanation categories;
determining, by one or more processors, respective baseline explanations for the explanation categories; and
generating, by one or more processors, the one of the training samples based on the one or more slang sentences and the baseline explanations.

9. The method of claim 6, wherein training the model based on the set of training samples comprises:
training, by one or more processors, the model based on the set of training samples, such that the model determines a slang category associated with the input sentence and provides the at least one explanation mapped to the determined slang category.

10. A computer-implemented method comprising:
receiving, by one or more processors, an input sentence from a user;
identifying, by one or more processors, slang from the input sentence; and
in response to the slang being identified, providing, by one or more processors, at least one explanation for the slang to the user.

11. A computer program product being tangibly stored on a non-transient machine-readable medium and comprising machine-executable instructions, the instructions, when executed on a device, causing the device to perform actions comprising:
extracting a plurality of slang sentences and respective explanations for the plurality of slang sentences from audio or video data;
generating a set of training samples by clustering the plurality of slang sentences and the explanations, each of the training samples comprising at least one slang sentence and at least one explanation corresponding to same slang; and
training a model based on the set of training samples, such that the model identifies slang from an input sentence and providing at least one explanation for the identified slang.

12. The computer program product of claim 11, wherein extracting the plurality of slang sentences and the explanations comprises:
determining a time slot when slang appears in the audio or video data by capturing an emotional reaction to the slang from the audio or video data;
extracting a first segment before the time slot and a second segment after the time slot from the audio or video data;
extracting a slang sentence triggering the emotional reaction from the first segment; and
extracting an explanation for the slang sentence from the second segment.

13. The computer program product of claim 12, wherein the emotional reaction is selected from the group consisting of laughter, applause, and silence.

14. The computer program product of claim 12, wherein extracting the slang sentence from the first segment comprises:
converting the first segment into a first text;
identifying a slang sentence triggering the emotional reaction from the first text by using a slang sentence identification model; and
in response to the slang sentence being identified, extracting the slang sentence from the first text.

15. The computer program product of claim 12, wherein extracting the explanation for the slang sentence from the second segment comprises:
converting the second segment into a second text;
identifying at least one sentence for explaining the slang sentence from the second text by using an explanation identification model; and
in response to the at least one sentence being identified, extracting the at least one sentence from the second text as the explanation for the slang sentence.

16. The computer program product of claim 11, wherein clustering the plurality of slang sentences and the explanations comprises:
clustering the plurality of slang sentences into slang categories, one of the slang categories comprising one or more slang sentences corresponding to same slang; and
mapping the explanations into the slang categories.

17. The computer program product of claim 16, wherein generating the set of training samples comprises:
generating one of the training samples based on the one or more slang sentences and a set of explanations mapped to the one of the slang categories.

18. The computer program product of claim 17, wherein generating the one of the training samples comprises:
clustering the set of explanations into explanation categories;
determining respective baseline explanations for the explanation categories; and
generating the one of the training samples based on the one or more slang sentences and the baseline explanations.

19. The computer program product of claim 16, wherein training the model based on the set of training samples comprises:
training the model based on the set of training samples, such that the model determines a slang category associated with the input sentence and provides the at least one explanation mapped to the determined slang category.
